(19) United States
(12) Patent Application Publication
(10) Pub. No.: US 2007/0225402 A1
(43) Pub. Date: Sep. 27, 2007

(54) Ultraviolet luminescent ink and security system using the same

(76) Inventors: Jae Young Choi, Suwon-si (KR); Sung Ho Jin, La Jolla, CA (US); Seong Jae Choi, Seoul (KR)

Correspondence Address: CANTOR COLBURN, LLP, 55 GRIFFIN ROAD SOUTH, BLOOMFIELD, CT, 06002, US

(21) Appl. No.: 11/519,112

(22) Filed: Sep. 11, 2006

(30) Foreign Application Priority Data
Mar. 24, 2006 (KR) 10-2006-0026938

(51) Int. Cl. C09D 11/00

(52) U.S. Cl. 523/160

(57) ABSTRACT

An ultraviolet luminescent ink is printed to form a pattern containing uniformly dispersed quantum dots without aggregation. In addition, the ultraviolet luminescent ink is transparent under natural light, so that the pattern is not visually observed, but emits light only upon UV irradiation. Therefore, the ultraviolet luminescent ink is useful in introducing codes in security articles, such as passports and bank bills. The ultraviolet luminescent ink can be used in the manufacture of security articles, such as passports, securities, bank bills, identification cards and credit cards. A security system using the ultraviolet luminescent ink is also disclosed.

This non-provisional application claims priority to Korean Patent Application No. 10-2006-0026938, filed on Mar. 24, 2006, and all the benefits accruing therefrom under 35 U.S.C. § 119(a), the contents of which in its entirety are herein incorporated by reference.

### BACKGROUND OF THE INVENTION

1. Field of the Invention

The present invention relates to an ultraviolet luminescent ink and a security system using the ultraviolet luminescent ink. More specifically, the present invention relates to an ultraviolet luminescent ink that is printed to form a pattern containing uniformly dispersed quantum dots without aggregation. The ultraviolet luminescent ink is transparent under natural light, so that the pattern is not visually observed, but emits light only upon ultraviolet irradiation. The ultraviolet luminescent ink and a security system using the ultraviolet luminescent ink of the present invention are useful in introducing codes in security articles, such as passports and bank bills.

2. Description of the Related Art

Conventional ink compositions that have been generally used to introduce codes in security articles for the prevention of forgery and alteration, as well as for identification, are invisible ultraviolet fluorescent inks emitting light at wavelengths of 254 nm and 365 nm under ultraviolet light. Various printing processes, including screen, gravure, letterpress and offset printing, are extensively used to apply the invisible ultraviolet fluorescent inks.

Phosphor powders as fluorescent materials used in the ultraviolet fluorescent inks emit fluorescence upon ultraviolet (“UV”) irradiation and have a particle size as large as 10 μm. Although the phosphor powders emit light upon UV irradiation, printed patterns using the ultraviolet fluorescent inks can be visually observed because the large particle size of the phosphor powders causes light scattering in the visible range. The large particle size of the phosphor powders causes the ultraviolet fluorescent inks to be visually opaque and visible, thus resulting in dangers of forgery, alteration and appropriation. Until now, no technology has been established that can solve the abovementioned problems associated with conventional luminescent fluorescent inks.

### BRIEF SUMMARY OF THE INVENTION

Therefore, the present invention has been made in view of the abovementioned problems of the prior art, and it is one aspect of the present invention to provide an ultraviolet luminescent ink that is transparent in the visible range and is thus not visually observed, but emits light upon UV irradiation and is thus discernible, resulting in enhanced security.

It is another aspect of the present invention to provide a security article comprising the ultraviolet luminescent ink.

It is yet another aspect of the present invention to provide a security system comprising an ultraviolet luminescent ink, an ultraviolet radiation unit for radiating ultraviolet light, and a detector for measuring light emitted from the ultraviolet luminescent ink which absorbs ultraviolet light radiated from the ultraviolet radiation unit.

In accordance with one exemplary embodiment of the present invention for achieving the above aspects, there is provided an ultraviolet luminescent ink including quantum dots, a dispersant and a binder.

In accordance with another exemplary embodiment of the present invention, there is provided a security article including the ultraviolet luminescent ink.

In accordance with yet another exemplary embodiment of the present invention, there is provided a security system including the ultraviolet luminescent ink and a detector.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 schematically shows the formation of a thin film in which quantum dots are dispersed by printing an ultraviolet luminescent ink of the present invention on a substrate to adhere the quantum dots to the substrate;

FIG. 2 shows photographs of the luminescence of thin films produced in Examples 1 to 6 of the present invention before and after UV irradiation;

FIG. 3 is a graph showing the variation in the absorbance of thin films produced in Examples 2 to 6 of the present invention as a function of wavelength;

FIG. 4 is a graph showing the luminescence intensity of thin films produced in Examples 1 to 6 of the present invention;

FIG. 5 shows photographs of the luminescence of a pattern before and after UV irradiation, the pattern being formed by printing an ultraviolet luminescent ink prepared in Example 1 of the present invention;

FIG. 6 is a photograph showing quantum dot inks prepared in Example 7 and Comparative Example 1 of the present invention;

FIG. 7 is a graph showing luminescence peaks of quantum dot inks prepared in Example 7 and Comparative Example 1 of the present invention; and

FIG. 8 shows conceptual views of a security system according to the present invention.

### DETAILED DESCRIPTION OF THE INVENTION

The present invention will now be described more fully hereinafter with reference to the accompanying drawings, in which exemplary embodiments of the present invention are shown. This invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The wavelengths that humans are able to visualize are dependent on the visual power of the humans, and typically lie in a range between about 380 nm and about 770 nm. Since phosphor powders that have been used as fluorescent materials have a particle size of several tens of micrometers, they cause light scattering in the visible range to produce their inherent colors and hence patterns printed using phosphor powders become visible.

In contrast, quantum dots cause no light scattering due to their small particle size (e.g., quantum dot size≦10 nm). Accordingly, quantum dots can be used to prepare transparent inks, and printed patterns using the transparent inks are invisible. However, since quantum dots emit light in the visible range upon ultraviolet (“UV”) irradiation, the shape of printed patterns using quantum dots can be recognized.

In addition, since quantum dots have a higher luminescence efficiency and emit a brighter light upon UV irradiation than conventional phosphors and fluorescent materials, the shape of printed patterns using quantum dots can be easily recognized.

Based on these characteristics of quantum dots, the present invention has been accomplished. Specifically, the present invention is intended to ensure more improved code printing and enhanced security in introducing codes in security articles by making printed patterns using invisible quantum dots but allowing the patterns to emit light only upon UV irradiation.

The ultraviolet luminescent ink of the present invention comprises quantum dots, a dispersant and a binder.

Group II-VI, Group III-V, Group IV-VI and Group IV compound semiconductor nanocrystals, and mixtures thereof may be used as the quantum dots constituting the ultraviolet luminescent ink of the present invention. Specific examples of the compound semiconductor nanocrystals include, for example, but are not limited to, CdS, CdSe, CdTe, ZnS, ZnSe, ZnTe, HgS, HgSe, HgTe, GaN, GaP, GaAs, GaSb, AlN, AlP, AlAs, AlSb, InN, InP, InAs, InSb, Si and Ge nanocrystals, and mixtures thereof. The nanoparticles may have a core-shell alloy structure. The size of quantum dots that can be used in the present invention is not particularly limited, but may range from about 2 nm to about 30 nm and more preferably from about 2 nm to about 10 nm.

The content of the quantum dots is preferably from about 0.03 parts to about 50 parts by weight, based on 100 parts by weight of the binder. If the content of the quantum dots is below 0.03 parts by weight, the intensity of light emitted from the quantum dots upon UV irradiation is so weak that the light cannot be readily observed. Meanwhile, if the content of the quantum dots is above 50 parts by weight, light scattering is caused by aggregation of the quantum dots, making the ultraviolet luminescent ink opaque in the visible range.

The ultraviolet luminescent ink of the present invention comprises a dispersant for uniformly dispersing the quantum dots. Since the quantum dots are highly cohesive in view of the characteristics of nanoparticles, they tend to form aggregates. If the quantum dots are not uniformly dispersed and are formed into aggregates, light scattering occurs in the visible range by the aggregates and thus the desired transparency cannot be attained. The dispersant allows the quantum dots to disperse in the form of nanocrystals on a polymer matrix used as the binder so that the quantum dots can sufficiently exhibit their inherent characteristics.

The dispersant consists of a head containing a polar group capable of being adsorbed on the surface of the quantum dots and an a polar tail capable of being adsorbed to the binder. Non-limiting examples of preferred dispersants include those consisting of a head containing a polar group selected from an amine group and its salts, a carboxylic acid group and its salts, a phosphoric acid group and its salts, a sulfonic acid group and its salts, and a hydroxyl group; and a tail selected from polyethylene glycol, polypropylene glycol and C₅-C₃₀ alkyl groups. It is preferred that the dispersant be highly compatible with the binder used.

The content of the dispersant is preferably in the range of about 10 parts to about 10,000 parts by weight, based on 100 parts by weight of the quantum dots. When the content of the dispersant is less than 10 parts by weight, the quantum dots are not sufficiently dispersed and tend to form aggregates. The aggregates thus formed cause light scattering, thus making the ultraviolet luminescent ink opaque, and lower the luminescence efficiency of the quantum dots upon UV irradiation, thus making it difficult to observe light emitted from the quantum dots. Meanwhile, when the content of the dispersant exceeds 10,000 parts by weight (e.g., the content of the quantum dots is relatively low), the intensity of light emitted from the quantum dots upon UV irradiation is so weak that the light cannot be readily observed.

The binder used in the ultraviolet luminescent ink of the present invention is a matrix serving to adsorb the quantum dots and enhance the adhesiveness of the ink. As the binder, a polymer having a molecular weight of about 1,000 to about 1,000,000 is used. Exemplary polymers include epoxy resins, modified epoxy resins, polyvinyl alcohol and its derivatives, polyvinyl phenol and its derivatives, polyacryl and its derivatives, polynorbornene and its derivatives, polyethylene glycol derivatives, polypropylene glycol derivatives, cellulose and its derivatives, polysiloxane derivatives, polystyrene, and copolymers thereof. Preferably, these polymers may contain a polar group, such as a hydroxyl group, a carboxylic acid group or its salt, a phosphoric acid group or its salt, a sulfonic acid group or its salt, or an amine group or its salt at the terminal position of their backbone or side chains.

The ultraviolet luminescent ink may further comprise an organic solvent to increase the compatibility between the quantum dots and the binder. Quantum dots are generally stored in an organic solvent, e.g., toluene, before use. Since the binder is poorly compatible with organic solvents, such as toluene, the ultraviolet luminescent ink may further comprise an organic solvent highly compatible with the binder, in addition to the dispersant, to improve the dispersibility of the quantum dots.

Any organic solvent may be used without any particular limitation if the organic solvent is compatible with the binder. Specific examples of such organic solvents include: alcohol-based solvents, such as ethanol, propanol, butanol and isopropyl alcohol; acetate-based solvents, such as ethyl acetate, butyl acetate and propylene glycol methyl ether acetate; amide-based solvents, such as dimethylacetamide and dimethylformamide; ketone-based solvents, such as cyclohexanone, methyl ethyl ketone, 4-heptanone, methyl isobutyl ketone, 1-methyl-2-pyrrolidinone, cyclohexanone and acetone; ether-based solvents, such as tetrahydrofuran and isopropyl ether; and mixtures thereof. The content of the organic solvent is about 10 parts to about 1,000,000 parts by weight, based on 100 parts by weight of the binder.

The ultraviolet luminescent ink of the present invention is printed on a substrate 10 to form a thin film having a predetermined pattern. As shown in FIG. 1, quantum dots 12 are uniformly dispersed without aggregation and are adhered to the substrate 10 so that they can efficiently exhibit their luminescence properties.

The ultraviolet luminescent ink of the present invention can be used in the manufacture of security articles by known coating and printing techniques.

As the security articles, there can be exemplified, without any limitation, passports, securities, bank bills, identification cards and credit cards, for example, but is not limited thereto.

The present invention provides a security system comprising the ultraviolet luminescent ink, an ultraviolet radiation unit for radiating ultraviolet light, and a detector for measuring light emitted from the ultraviolet luminescent ink which absorbs ultraviolet light radiated from the ultraviolet radiation unit.

The ultraviolet light radiated from the ultraviolet radiation unit may be in the wavelength range of about 530 nm to about 540 nm.

Hereinafter, the present invention will be explained in more detail with reference to the following examples. However, these examples are given for the purpose of illustration and are not intended to limit the present invention.

### EXAMPLE 1

First, 1 ml of a solution of quantum dots (CdSe/ZnS core-shell, 535 nm Catskill Green, Evident Tech.) in toluene, 0.2 ml of HN₂CH₂CH₂—PEG(7) (MAPEG-7, Chyrogenics) as a dispersant and 1 ml of ethanol were mixed. 10 μl of the mixture was added to 1 ml of an epoxy resin to prepare an ultraviolet luminescent ink. The quantum dots were composed of a CdSe core and a ZnS shell surrounding the CdSe core. The quantum dots had a diameter of 7 nm, and emitted green light.

Thereafter, the ultraviolet luminescent ink was filled in a space formed between two cover glasses (thickness: about 150 μm) arranged at a fixed interval on a 1 mm-thick transparent quartz plate. The ultraviolet luminescent ink was cured at 100° C. for 2 hours to produce a transparent ultraviolet luminescent thin film.

### EXAMPLES 2-6

Ultraviolet luminescent thin films were produced in the same manner as in Example 1, except that 40 μl, 120 μl, 200 μl, 280 μl and 400 μl of the mixture were added to 1 ml of an epoxy resin to prepared respective ultraviolet luminescent inks for Examples 2-6.

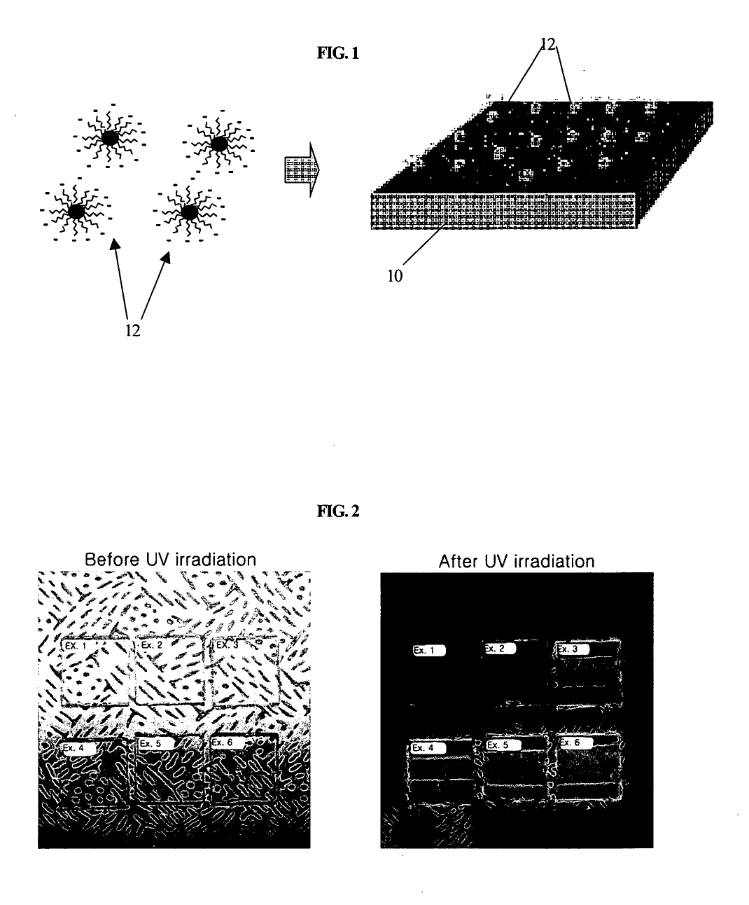

The luminescence of the thin films produced in Examples 1 to 6 before and after UV irradiation was observed, and the results are shown in FIG. 2. The photographs shown in FIG. 2 demonstrate that a strong green light emission was observed with increasing content of the quantum dots, indicating high luminescence efficiency of the quantum dots.

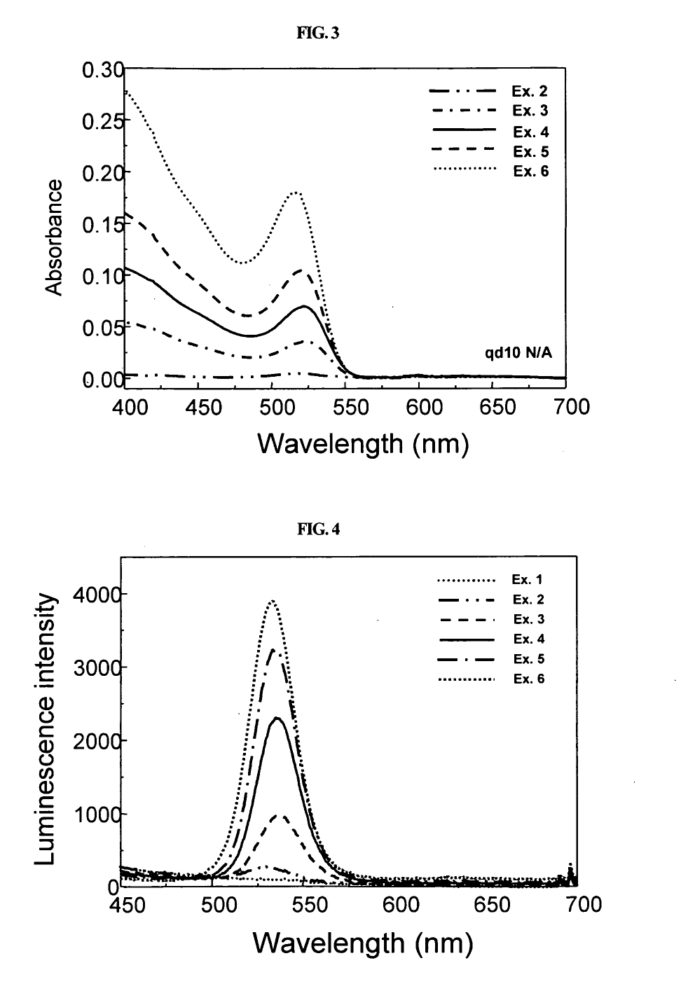

FIG. 3 is a graph showing the variation in the absorbance of the thin films produced in Examples 2 to 6 as a function of wavelength. Referring to FIG. 3, the thin films absorbed light of about 550 nm or less, which indicates that the absorption intensity of the thin films was increased with increasing content of the quantum dots.

FIG. 4 is a graph showing the variation in the luminescence intensity of the thin films produced in Examples 1 to 6 as a function of wavelength. In the quantum dot inks prepared in Examples 1 to 6, no absorption peak arising from light scattering in the visible range was observed. Referring to FIG. 4, the thin films showed luminescence peaks at around 530-540 nm and increased luminescence intensity with increasing content of the quantum dots.

After the ultraviolet luminescent ink prepared in Example 1 was printed in a predetermined pattern between quartz plates, the luminescence of the pattern before and after UV irradiation was visually observed. The results are shown in FIG. 5. From the photographs shown in FIG. 5, it could be confirmed that the ultraviolet luminescent inks of the present invention were transparent under natural light, making it impossible to recognize patterns, and emitted light only upon UV irradiation. These results indicate that the ultraviolet luminescent inks ensure more enhanced security in introducing codes in security articles, such as passports, securities, bank bills, identification cards and credit cards, for example.

### EXAMPLE 7

First, 1 ml of a solution of quantum dots (CdSe/ZnS core-shell, 620 nm Maple Red Orange, Evident Tech.) in toluene, 0.2 ml of HN₂CH₂CH₂—PEG(7) (MAPEG-7, Chyrogenics) as a dispersant and 1 ml of ethanol were mixed. 10 μl of the mixture was added to 1 ml of an epoxy resin to prepare an ultraviolet luminescent ink. The quantum dots were composed of a CdSe core and a ZnS shell surrounding the CdSe core. The quantum dots had a diameter of 9 nm, and emitted red light.

Thereafter, the ultraviolet luminescent ink was filled in a space formed between two cover glasses (e.g., thickness: about 150 μm) arranged at a fixed interval on a 1 mm-thick transparent quartz plate. The ultraviolet luminescent ink was cured at 100° C. for 2 hours to produce a transparent ultraviolet luminescent thin film.

### COMPARATIVE EXAMPLE 1

First, 1 ml of a solution of quantum dots (CdSe/ZnS core-shell, 535 nm Catskill Green, Evident Tech.) in toluene and 1 ml of ethanol were mixed. 10 μl of the mixture was added to 1 ml of an epoxy resin to prepare an ultraviolet luminescent ink. The quantum dots were composed of a CdSe core and a ZnS shell surrounding the CdSe core. The quantum dots had a diameter of 7 nm, and emitted green light.

Thereafter, the ultraviolet luminescent ink was filled in a space formed between two cover glasses (e.g., thickness: about 150 μm) arranged at a fixed interval on a 1 mm-thick transparent quartz plate. The ultraviolet luminescent ink was cured at 100° C. for 2 hours to produce a transparent ultraviolet luminescent thin film.

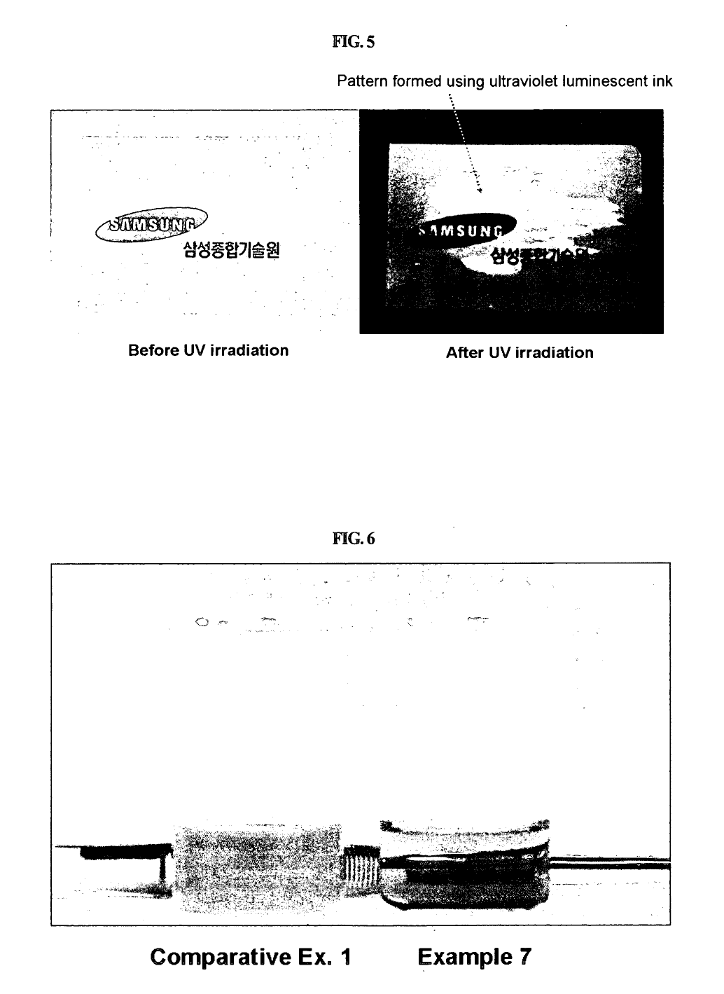

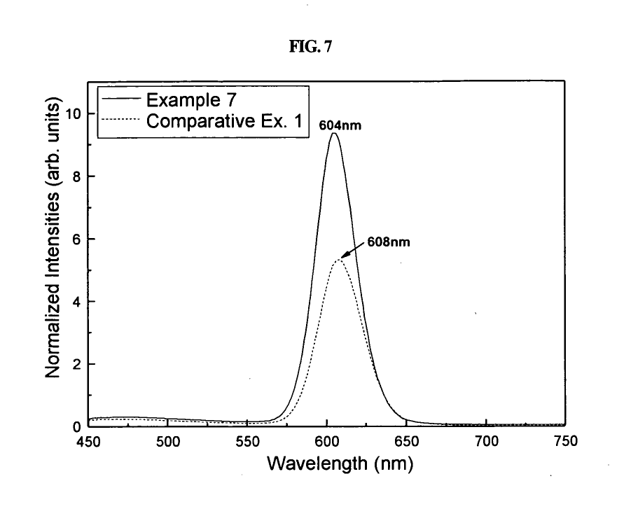

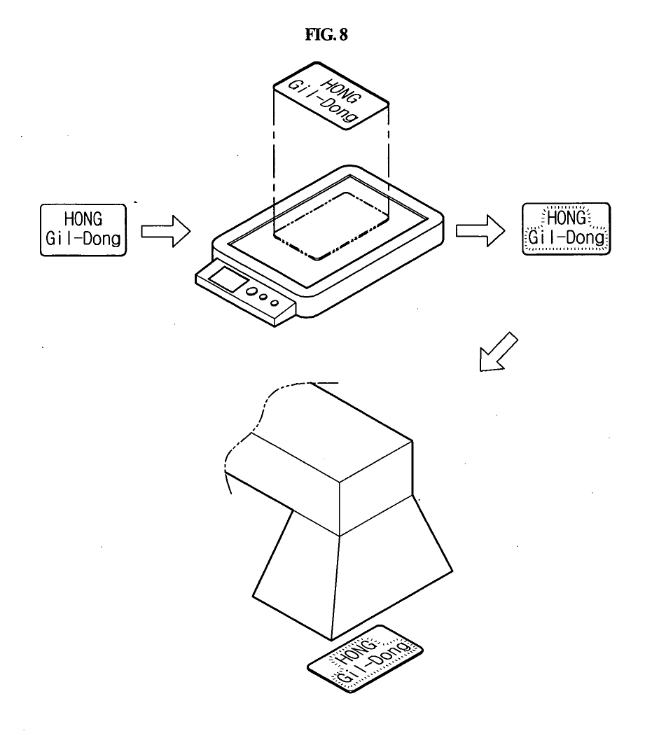

FIG. 6 is a photograph showing the quantum dot ink comprising a dispersant (Example 7) and the quantum dot ink comprising no dispersant (Comparative Example 1). FIG. 7 is a graph showing luminescence peaks of the quantum dot inks prepared in Example 7 and Comparative Example 1.

The quantum dot ink prepared in Comparative Example 1 was opaque, whereas the quantum dot ink prepared in Example 7 was transparent. The quantum dot ink prepared in Comparative Example 1 showed a luminescence intensity 37% lower than that of the quantum dot ink prepared in Example 7. In addition, the luminescence peak of the quantum dot ink prepared in Comparative Example 1 was red-shifted, relative to that of the quantum dot ink prepared in Example 7. These results are due to aggregation of the quantum dots, which occurred because no dispersant was used, in the quantum dot ink prepared in Comparative Example 1.

Therefore, it can be concluded that the use of a dispersant is required to allow the quantum dot inks to emit bright light upon UV irradiation.

As apparent from the above description, the ultraviolet luminescent ink comprising nanometer-sized quantum dots according to the present invention is visually transparent and invisible, but emits light only upon UV irradiation. Therefore, the ultraviolet luminescent ink of the present invention can be used as a sensing element for use in detectors, a material for the prevention of forgery and alteration, or a security material. The ultraviolet luminescent ink of the present invention can be used in the manufacture of security articles, such as passports, securities, bank bills, identification cards and credit cards, for example, but is not limited thereto.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An ultraviolet luminescent ink comprising quantum dots, a dispersant and a binder.

2. The ultraviolet luminescent ink according to claim 1, wherein the quantum dots are selected from the group consisting of Group II-VI, Group III-V, Group IV-VI and Group IV compound semiconductor nanocrystals, and mixtures thereof.

3. The ultraviolet luminescent ink according to claim 1, wherein the quantum dots are selected from the group consisting of CdS, CdSe, CdTe, ZnS, ZnSe, ZnTe, HgS, HgSe, HgTe, GaN, GaP, GaAs, GaSb, AlN, AlP, AlAs, AlSb, InN, InP, InAs, InSb, Si and Ge nanocrystals, and mixtures thereof.

4. The ultraviolet luminescent ink according to claim 1, wherein the quantum dots have a core-shell structure.

5. The ultraviolet luminescent ink according to claim 1, wherein the quantum dots are present in an amount of about 0.03 parts to about 50 parts by weight, based on 100 parts by weight of the binder.

6. The ultraviolet luminescent ink according to claim 1, wherein the dispersant consists of a head containing a polar group capable of being adsorbed on the surface of the quantum dots and an apolar tail capable of being adsorbed to the binder.

7. The ultraviolet luminescent ink according to claim 6, wherein the head of the dispersant is selected from the group consisting of an amine group and its salts, a carboxylic acid group and its salts, a phosphoric acid group and its salts, a sulfonic acid group and its salts, and a hydroxyl group; and the tail of the dispersant is selected from the group consisting of polyethylene glycol, polypropylene glycol and C₅-C₃₀ alkyl groups.

8. The ultraviolet luminescent ink according to claim 1, wherein the dispersant is present in an amount of about 10 parts to about 10,000 parts by weight, based on 100 parts by weight of the quantum dots.

9. The ultraviolet luminescent ink according to claim 1, wherein the binder is selected from the group consisting of epoxy resins, modified epoxy resins, polyvinyl alcohol and its derivatives, polyvinyl phenol and its derivatives, polyacryl and its derivatives, polynorbornene and its derivatives, polyethylene glycol derivatives, polypropylene glycol derivatives, cellulose and its derivatives, polysiloxane derivatives, polystyrene, and copolymers thereof.

10. The ultraviolet luminescent ink according to claim 9, wherein the binder contains a polar group selected from a hydroxyl group, a carboxylic acid group and its salts, a phosphoric acid group and its salts, a sulfonic acid group and its salts, and an amine group and its salt at the terminal position of its backbone or side chains.

11. The ultraviolet luminescent ink according to claim 1, further comprising an organic solvent.

12. The ultraviolet luminescent ink according to claim 11, wherein the organic solvent is selected from the group consisting of alcohol-based solvents, including ethanol, propanol, butanol and isopropyl alcohol; acetate-based solvents, including ethyl acetate, butyl acetate and propylene glycol methyl ether acetate; amide-based solvents, including dimethylacetamide and dimethylformamide; ketone-based solvents, including cyclohexanone, methyl ethyl ketone, 4-heptanone, methyl isobutyl ketone, 1-methyl-2-pyrrolidinone, cyclohexanone and acetone; ether-based solvents, including tetrahydrofuran and isopropyl ether; and mixtures thereof.

13. The ultraviolet luminescent ink according to claim 11, wherein the organic solvent is present in an amount of about 10 parts to about 1,000,000 parts by weight, based on 100 parts by weight of the binder.

14. A security article comprising an ultraviolet luminescent ink, the ultraviolet luminescent ink comprising quantum dots, a dispersant and a binder.

15. The security article according to claim 14, wherein the security article is selected from the group consisting of passports, securities, bank bills, identification cards, and credit cards.

16. A security system, comprising:
an ultraviolet luminescent ink, the ultraviolet luminescent ink comprising quantum dots, a dispersant and a binder;
an ultraviolet radiation unit for radiating ultraviolet light; and
a detector for measuring light emitted from the ultraviolet luminescent ink which absorbs ultraviolet light radiated from the ultraviolet radiation unit.

17. The security system according to claim 16, wherein
